(19) United States
(12) Patent Application Publication
(10) Pub. No.: US 2026/0194256 A1
(43) Pub. Date: Jul. 9, 2026

(54) ACOUSTIC METAMATERIALS

(71) Applicants: The University of Sussex, Brighton, Sussex (GB); Metasonixx Limited, London, Greater London (GB)

(72) Inventors: Gianluca Memoli, Brighton (GB); Abdelhalim Azbaid El Ouahabi, Brighton (GB); Lorenzo Bonoldi, Brighton (GB); Letizia Chisari, Milan (IT)

(21) Appl. No.: 18/879,124

(22) PCT Filed: Jun. 29, 2023
(86) PCT No.: PCT/GB2023/051704

§ 371 Date: Dec. 26, 2024

(30) Foreign Application Priority Data
Jun. 29, 2022 (GB) 2209568.1

(51) Int. Cl. F24F 13/24

(52) U.S. Cl. CPC F24F 13/24; F24F 2013/242; F24F 2013/245

(57) ABSTRACT

A device for controlling noise comprising one or more acoustic metamaterial cells arranged relative to a flow passage such that when an acoustic wave is incident on the device, a first portion of the acoustic wave propagates through the flow passage and a second portion of the acoustic wave propagates through the one or more acoustic metamaterial cells, the acoustic metamaterial cells being structured such that the second portion of the acoustic wave is thereby delayed relative to the first portion of the wave, and the first and second portions of the acoustic wave destructively interfere to provide noise reduction at one or more frequencies based on the respective time delays associated with the one or more acoustic metamaterial cells.

The technology described herein relates generally to devices for manipulating acoustic waves. In particular, the technology described herein utilises acoustic metamaterials to provide noise control (e.g. noise reduction), particularly for in-line flow arrangements.

### BACKGROUND

The use of acoustic metamaterials to manipulate acoustic waves has been the subject of various developments in recent years. There are various applications where this might be desirable. One area that has recently been explored is the use of acoustic metamaterials for noise control wherein the acoustic metamaterial is designed to selectively reduce or accentuate certain frequencies of sound.

For example, WO 2020/208380 (The University of Sussex) describes various acoustic metamaterial systems and applications of such systems for noise reduction.

The Applicants however believe that there remains scope for improvements in this regard.

### SUMMARY

A first aspect of the technology described herein comprises a device for controlling noise, wherein the device comprises:
a flow passage that is open to allow air or another fluid to flow through the flow passage in a primary flow direction; and
one or more acoustic metamaterial cells, wherein each of the one or more acoustic metamaterial cells is provided with an inlet opening on a first side of the acoustic metamaterial cell, an outlet opening on a second, different side of the acoustic metamaterial cell, and an internal channel extending between the inlet and outlet openings and arranged to allow air or another fluid to flow between the inlet and outlet openings of the acoustic metamaterial cell through the internal channel of the acoustic metamaterial cell, and wherein each of the one or more acoustic metamaterial cells is structured such that the respective internal channel for the acoustic metamaterial cell provides a tortuous flow path through the acoustic metamaterial cell between the inlet and outlet openings, each acoustic metamaterial cell being configured to introduce a respective time delay to a portion of an acoustic wave incident at the inlet opening of the acoustic metamaterial cell based on the structure of the internal channel;
the one or more acoustic metamaterial cells being arranged relative to the flow passage such that when an acoustic wave propagating through air or another fluid is incident on the device, a first portion of the acoustic wave propagates through the flow passage and a second portion of the acoustic wave propagates through the one or more acoustic metamaterial cells, the second portion of the acoustic wave thereby being delayed relative to the first portion of the wave, and the first and second portions of the acoustic wave destructively interfering to provide noise reduction at one or more frequencies based on the respective time delays associated with the one or more acoustic metamaterial cells.

The technology described herein generally relates to noise control, in particular for in-line flow arrangements, such as for heating, ventilation and air conditioning (‘HVAC’) or other similar applications, e.g. where there is a primary flow of air or another fluid through a pipe or other such conduit and wherein noise also primarily propagates through the conduit through the air or another fluid in the conduit (e.g. since the air or other fluid in the conduit will act as a medium through which the acoustic waves associated with the noise can propagate; in that respect note that the acoustic waves may propagate along the same direction as the primary flow, e.g. such as noise originating from the fan or pump which is itself actually generating the primary flow but may also propagate in another, e.g. the opposite, direction to the primary flow, e.g. such as external noise, for instance traffic noise, propagating through a building's ventilation or air conditioning outlet against the direction of the primary flow, for example).

The technology described herein provides a device that can in embodiments be installed or formed in-line with the primary flow in order to control, e.g., and preferably, reduce, associated noise (propagating through the fluid in the conduit in either direction), whilst also allowing for increased flow throughput (and flow control) within the device, as will be explained further below.

Thus, in preferred embodiments, the device is designed for in-line flow applications. In embodiments, therefore, the device may be designed to be installed within, or connected to, a pipe or other flow conduit through which a primary flow of air or some other fluid (such as water, oil, etc.) flows in use. The device is then designed to reduce noise propagating through the air or other fluid from one (upstream/downstream) side of the device to the other side (downstream/upstream, respectively) of the device, whilst still allowing significant flow through the device in the primary flow direction. The device can thus be, and preferably is, installed in-line with the primary flow through a flow conduit and used to attenuate noise propagating through the air or other fluid in the conduit from one (upstream/downstream) side of the device to the other side (downstream/upstream, respectively) of the device. That is, embodiments of the technology described herein enable control over both: (i) noise reduction at a range of frequencies; and (ii) the specific flow dynamics of the air or another fluid flowing through the device.

In preferred embodiments, the device, or at least the arrangement of acoustic metamaterial cells within the device, therefore defines a substantially circular or polygonal perimeter for use for in-line noise control within a pipe or other conduit having a corresponding circular or polygonal perimeter. This then facilitates installation and/or connection of the device in-line into an existing flow conduit. Various arrangements would be possible in this regard.

The device of the technology described herein utilises acoustic metamaterial cells that are (each) capable of encoding a particular time (or phase) delay. It will be appreciated that the acoustic metamaterial cells are thus configured to introduce time delays by effectively slowing down acoustic waves passing through the acoustic metamaterial cell. Each acoustic metamaterial cell may thus be configured to introduce a particular time delay to a portion of an acoustic wave passing through the acoustic metamaterial cell.

In particular, in the technology described herein, the physical structure of the acoustic metamaterial cells may be designed so as to cause the acoustic waves to travel an extended effective path length, L_{eff}, so that it takes longer for the acoustic waves to transit the acoustic metamaterial cell than it would if the acoustic waves travelled directly from one side of the acoustic metamaterial cell to the other. Additionally, or alternatively, the acoustic metamaterial cells may be configured so that the speed of sound, c, within the acoustic metamaterial cell is changed (i.e. reduced) relative to the speed of sound in the ambient medium cₛ. As will be appreciated, the speed v_{f} of the flow of the air or other fluid through which the acoustic waves propagate may also impact the speed of sound. To a first approximation, the speed of sound for acoustic waves propagating with the flow may be c_{f}~c+v_{f}, and the speed of sound for acoustic waves propagating against the flow may be c_{f}~c+v_{f}. Of course, the skilled person will be aware of how to calculate higher order terms for different acoustic regimes and/or flow dynamic regimes. In general, the time delay introduced by the acoustic metamaterial cells may be of the order Δt~L_{eff}/c (in static air or other fluid) or Δt~L_{eff}/c_{f} (for situations including flow).

It will be appreciated that the effect of the time delay introduced by an acoustic metamaterial cell is that for an incident acoustic wave at a particular frequency the cell will introduce a phase delay, wherein the phase delay angle is given by Δφ=k.L_{eff}, where k is the wavenumber of the incident wave. That is, the phase delays are generally frequency dependent. Thus, it will be understood that where reference is made herein to a “time delay”, this may alternatively be considered as a “phase delay” that depends on the frequency of the incident acoustic wave and that the time delay and phase delay values may be related to each other depending on the operating frequency or frequencies.

Depending on the design of the acoustic metamaterial cells, the time delay may depend on the frequency of the incident acoustic wave or may be essentially frequency independent. Typically, each acoustic metamaterial cell will be designed to introduce a certain time or phase delay at a respective operating frequency. Of course, when an acoustic wave of a different frequency is incident on the acoustic metamaterial cell, there will still be an associated delay, but the duration of the delay may be different. Thus, the device may be optimised or designed for operating at a selected one or more frequencies. The device may still provide noise reduction at other frequencies, albeit potentially in a less optimised manner. To extend the frequency response, the device may also use combinations of different acoustic metamaterial cells, or multiple devices may be combined in series, as will be explained further below.

Furthermore, it has been found that the operating frequency and bandwidth of an acoustic metamaterial cell may generally be related to the transmission of acoustic waves through the acoustic metamaterial cell (essentially because the acoustic metamaterial cells may act as resonant structures in some directions of propagation). That is, the transmission efficiency of each of the acoustic metamaterial cells may provide a further parameter for controlling or adjusting the output of an acoustic metasurface, particularly to provide a different frequency response. Thus, in embodiments, instead of configuring an acoustic metamaterial cell with a relatively high (e.g. substantially 100%, e.g., greater than about 95%) efficiency at the operating frequency, the transmission efficiency of the acoustic metamaterial cell(s) may be selected or adjusted in order to control (e.g. vary) the operation performed by the acoustic metasurface. For instance, each of the acoustic metamaterial cells may have an associated amplitude (e.g. or intensity) value representing the relative amplitude (e.g. intensity), or change in amplitude (e.g.

intensity), introduced by that acoustic metamaterial cell to an incident acoustic wave of a particular frequency (e.g. at the operating frequency of the device) passing through the acoustic metamaterial cell. Thus, by appropriately selecting or configuring the amplitude (e.g. intensity) values for an acoustic metamaterial cell it is possible to change the acoustic manipulation provided by that acoustic metamaterial cell. For example, the amplitude (e.g. intensity) value for an acoustic metamaterial cell may be selected or configured e.g. to increase or optimise the operating bandwidth for that acoustic metamaterial cell.

(It will be appreciated that the structure of the cells will also delay the flow of air or another fluid through the cell; however the air or another fluid essentially serves as a medium through which the acoustic waves propagate, and the flow speed is generally lower than the speed of sound through the air or another fluid (although it is appreciated that they could be similar). The delay in flow will essentially add a flow boundary at the outlet opening of the cell or in some specific positions inside it.)

The cells thus generally comprise of “acoustic metamaterials”. Acoustic metamaterials are generally characterised by their effective mass density and bulk modulus. The structure of an acoustic metamaterial may be engineered to perform various manipulations, and may for instance be engineered to have negative effective parameters leading to interesting effects equivalent to negative refraction and sub-diffraction focussing. In this context, the metamaterials effectively slow down or speed up the sound waves hence altering the effective speed of sound and/or path length within the material. Most of the historic studies of acoustic metamaterials are typically limited to audible frequencies up to 20 kHz, and are designed to illustrate a specific principle, or to fit a specific purpose e.g. a lens with a fixed focus. That is, acoustic metamaterials have typically been used to create relatively limited, static structures. By contrast, the technology described herein presents more flexible solutions for controlling potentially arbitrary acoustic waves.

In the technology described herein, the acoustic metamaterial cells generally comprise an inlet opening, an outlet opening, and an internal channel extending between the inlet and outlet openings. Fluid can therefore flow between the inlet and outlet openings through the internal channel. Correspondingly, acoustic waves can propagate through the fluid (flow) within the acoustic metamaterial cell. Thus, noise may primarily also propagate through the flow within the internal channel. In preferred embodiments the acoustic metamaterial cells can be used in either direction. Further, as mentioned above, it will be understood that the direction of flow may be the same as or opposite to the direction in which the noise propagates. Thus, in embodiments, an acoustic metamaterial cell (and generally the device) may be mounted either way round relative to the primary flow of air or other fluid through the device. In other words, which opening is the “inlet” and which opening is the “outlet” may depend on the orientation in which the acoustic metamaterial cell is mounted. In that case, the acoustic metamaterial cells (and hence the device) preferably function substantially symmetrically such that the device can reduce noise from either side. In other embodiments however the cells (and hence device) may be designed for use in a particular orientation with respect to the direction of propagation of the flow and/or the direction of propagation of the acoustic waves through the flow. That is, in some cases, it may be desirable for the relative size and/or position of the inlet and outlet openings to differ, for example to provide greater flow control.

Each acoustic metamaterial cell is structured such that the respective internal channel for the acoustic metamaterial cell provides a tortuous flow path between the inlet and outlet openings through the acoustic metamaterial cell. By “tortuous” it is meant that the internal channel defines a flow path that changes direction at least once. For instance, preferably, the internal channel defines a flow path that changes direction multiple times such that air or other fluid flowing through the internal channel will be caused to follow a substantially labyrinthine or meandered path. For example, the internal channel may comprise a series of one or more substantially “U” or “V” shaped bends to define a serpentine or zig zagged flow path. As mentioned above, acoustic waves associated with the flow will propagate through the fluid flow, and will therefore also primarily propagate along the flow path. The structure of the internal channel thus determines for each acoustic metamaterial cell the respective time delay that will be introduced to a portion of an acoustic wave incident at the inlet opening of the acoustic metamaterial cell.

As mentioned above, the device comprising one or more acoustic metamaterial cell(s), as described herein, is preferably designed for in-line flow arrangements. The device is thus preferably designed to reduce noise associated with the flow whilst still allowing significant volumetric flow through the device. The device as a whole is therefore preferably substantially open to permit fluid to flow from one side of the device to the other.

For instance, in addition to the acoustic metamaterial cells (which are themselves open to permit flow between the inlet and outlet openings, but in which the flow is caused to travel an extended or restricted path), the device also comprises at least one flow passage that is substantially open such that the air or other fluid is allowed to (and does) flow through the flow passage without delay. Thus, the at least one flow passage may be essentially open to allow the air or other fluid to flow without restriction (e.g. other than any boundary conditions).

The flow passage preferably extends directly from one side of the device to the other. For instance, the flow passage preferably extends along the axis of the device in the primary flow direction. In that respect, the device may have a generally cylindrical or prismatic form with the device being symmetric about an axis in the primary flow direction. For example, the flow passage may be generally co-axial with the device axis. As will be appreciated, this may help simplify integration of the device into appliances having tubular geometries, such as in ventilation pipes or in the tubular inlets and outlets of systems such as ventilation systems, as there is then a direct continuation of the flow at least through the flow passage. The flow passage may thus comprise a first opening in a first plane that is preferably perpendicular to the primary flow direction and may extend to a second opening in a second plane that is parallel to the first plane so as to allow air or another ambient medium to flow straight through the flow passage in the primary flow direction. However, it is also contemplated that the device may be curved in which case the flow passage may correspondingly be curved. In that case, the device axis may trace a curved line. This then allows the device to be installed within a curved pipe section, for example.

The acoustic metamaterial cells are arranged relative to the flow passage such that when an acoustic wave (e.g. propagating through air or another fluid) is incident on the device, a first portion of the acoustic wave (flow) propagates through the flow passage and a second portion of the acoustic wave (flow) propagates through the one or more acoustic metamaterial cells. In this way, due to the time delays introduced to the portions of the acoustic wave passing through the acoustic metamaterial cells relative to the portion of the acoustic wave that passes through the open flow channel (i.e. without delay or restriction), the devices causes the first and second portions of the acoustic wave to destructively interfere to provide noise reduction at least at one or more frequencies based on the respective time delays associated with the one or more acoustic metamaterial cells.

The acoustic metamaterial cells may be arranged relative to the flow channel in any suitable and desired manner. Various arrangements would be possible in this regard.

In a particularly preferred embodiment the one or more acoustic metamaterial cells are arranged radially outwardly of an inner (e.g. central) flow passage that is open to allow air or another ambient medium to flow through the inner flow passage substantially without delay (e.g. without restriction) such that when an acoustic wave propagating through air or another fluid is incident on the device, a first portion of the acoustic wave propagates through the inner flow passage and a second portion of the acoustic wave propagates through the one or more acoustic metamaterial cells, the first and second portions of the acoustic wave destructively interfering to provide noise reduction at one or more frequencies based on the respective time delays associated with the one or more acoustic metamaterial cells. Thus, in a preferred embodiment, the device may have a generally cylindrical or prismatic form, with the acoustic metamaterial cells disposed towards the perimeter of the device, radially outwards of a central flow passage. Preferably the arrangement of the one or more acoustic metamaterial cells extends circumferentially around the inner (e.g. central) flow passage.

Accordingly, in embodiments, the one or more acoustic metamaterial cells may be arranged at or substantially at the perimeter of the cylindrical or prismatic device. For instance, the one or more acoustic metamaterial cells may be arranged such that a side of each of the one or more acoustic metamaterial cells, which is the side radially furthest from the cylindrical axis, is at, or substantially at, the perimeter of the cylindrical perimeter. The cells may therefore in embodiments abut the inner walls of the device.

In some embodiments, the one or more acoustic metamaterial cells may be arranged so as to define the entirety of the cylindrical perimeter. Alternatively, in some preferred embodiments, a plurality of acoustic metamaterial cells may be provided at respective different positions with gaps between adjacent cells so as to define only a portion of the cylindrical perimeter.

Preferably, therefore, there are a plurality of acoustic metamaterial cells that are arranged at different circumferential positions around the inner (central) flow passage. By ‘circumferential’ it is meant in the circumferential direction i.e. substantially perpendicular to the axial (flow) and radial directions. For instance, the plurality of acoustic metamaterial cells may be arranged in a circular or elliptical arrangement around the inner flow passage. It will be appreciated however that circumferential as used herein does not necessarily imply a continuously curved or circular or elliptical arrangement, and the cells may generally be disposed in any suitable arrangement such that a circle or ellipse can be drawn which passes through each of the cells when viewed in cross section along the axis of the device (in the primary flow direction). Thus, the arrangement of acoustic metamaterial cells may be, and in preferred embodiments is, substantially polygonal, wherein the acoustic metamaterial cells are arranged circumferentially around the flow passage with polygonal symmetry. For example, in some preferred embodiments the device may comprise five or six (or more) acoustic metamaterial cells. In such cases, the acoustic metamaterial cells may be arranged in a pentagonal or hexagonal arrangement, for example, depending on the number of acoustic metamaterial cells.

In general, however, the device may comprise any suitable and desired number of acoustic metamaterial cells. For example, in embodiments, there may be two, three, four, five, six, seven, eight, nine, ten, eleven, twelve or more acoustic metamaterial cells arranged around the flow passage. In some embodiments, as discussed further below, there may be only a single acoustic metamaterial cell.

Where the device comprises plural acoustic metamaterial cells, these may be a plurality of acoustic metamaterial cells of the same type, or may include acoustic metamaterial cells of two or more different types. Where the acoustic metamaterial cells comprise different types of cells, this may mean that different delays are introduced at different respective position within the device. This can provide further control over the noise reduction. For example, the arrangement of the delays may be configured to further manipulate the acoustic waves in a desired manner. Or, by using different cells having different delays, it may be possible to effectively extend the frequency range of the device.

Preferably all of the acoustic metamaterial cells are designed to introduce a respective time delay. In that case, the different types of cell preferably operate in the same way but have different structures so as to introduce different delays. However, it is also contemplated that only some of the acoustic metamaterial cells are designed to introduce a respective time delay in the manner designed herein, and at other positions in the device other types of acoustic cells may be used. For example, the device may comprise a combination of acoustic metamaterial cells of the type described herein that introduce respective time delays and other cells, e.g. that act as resonant cavities. Various arrangements would be possible in that regard.

Where there are plural acoustic metamaterial cells, these may all be arranged at the same axial position (in the direction of the primary flow), such that the device presents an essentially planar surface, preferably perpendicular to the primary flow direction. In that case, an acoustic wave, or component thereof, propagating through air or another fluid that is flowing in the direction of the primary flow is preferably incident on all of the acoustic metamaterial cells at the same time. Preferably the inlet and outlet openings are provided in this surface such that openings to the acoustic metamaterial cells are in-line with the primary flow direction. That is, the openings to the acoustic metamaterial cells preferably both open in the axial (flow) direction. However, it is also contemplated that one of the openings may open radially.

Thus, in preferred embodiments, the acoustic metamaterial cells are arranged within the same plane. The acoustic metamaterial cells could however also be staggered or otherwise arranged at different axial positions (in the direction of the primary flow) if that were desired. Similarly, in some embodiments, the device may comprise multiple groups of acoustic metamaterial cells, such that there are effectively two such devices provided in series with one another. Various arrangements would be possible in that regard as will be explained further below.

Where there are a plurality cells, the device preferably comprises a prime number of cells. The inventors have discovered that it may be beneficial to have a prime number of acoustic metamaterial cells. In this respect, the inventors recognise that having a prime number of cells will reduce the number of symmetries associated with the arrangement of cells. That is, when not using a prime number of cells, the arrangement of cells may lead to a higher order of (e.g. rotational) symmetry. Accordingly, the associated acoustic system eigenmodes may comprise one or more degenerate eigenmodes (wherein one or more eigenmodes share the same eigenvalue), or at least the associated acoustic system may have two or more eigenmodes which may be relatively closely spaced.

As will be understood, in a system having degenerate eigenmodes, small external perturbations can easily lift the degeneracy, splitting the eigenmodes and leading to large couplings therebetween (or indeed, relatively closely spaced eigenmodes, leading to relatively larger eigenvalue shifts and relatively larger couplings). By using a prime number of cells, the associated acoustic eigenmodes are better isolated from adjacent eigenmodes (i.e., the respective eigenvalues are spaced further apart), and are thus more robust to external perturbations inducing significant couplings between eigenmodes. That is, external perturbations may have a smaller effect on the system comprising a prime number of cells relative to a system comprising a non-prime number.

Thus, by restricting available eigenmodes and increasing their robustness, it is possible to provide more reliable device performance. In contrast, when not using a prime number of cells, this means that device performance may be more susceptible to variations in manufacture or use since the notionally same device when used in two different contexts might perform very differently, depending on which eigenmode is excited. Accordingly, the noise reduction assembly may comprise a prime number of acoustic metamaterial cells.

Advantageously, a device having a prime number of cells may be able to be placed in different pipes, or may be subject to a broader range of changing flow conditions (as compared to a device having a non-prime number of cells), without undesirably or uncontrollably changing the noise reduction response of the device. Moreover, the inventors have discovered that having a prime number of acoustic metamaterial cells arranged circumferentially around the inner flow passage may reduce the number of peaks in the acoustic spectrum output downstream of the device. For instance, as a prime number of acoustic metamaterial cells may reduce the symmetry of the associated acoustic system, the number of available acoustic modes are thereby reduced. It has been found that, for certain frequencies, the prime number of cells may have similar to better noise reduction than a comparable non-prime number of cells. For instance, it has been found that a device with seven acoustic metamaterial cells may have better, more reproducible noise reduction at certain frequencies than a comparable device having e.g. ten acoustic metamaterial cells. However, as will be appreciated, the seven acoustic metamaterial cells will block/restrict relatively less of the flow than a comparable device having ten cells, such that a similar or better performance in noise reduction can be achieved by using seven cells whilst advantageously restricting less of the flow through the device.

As will be appreciated, reducing the number of available modes may also simplify modelling of the expected acoustic spectrum output downstream of the device arising from the first and second portions of the acoustic wave destructively interfering to provide noise reduction at one or more frequencies based on the respective time delays associated with the one or more acoustic metamaterial cells. Accordingly, this may simplify optimization of the noise reduction with respect to transmission of the flow of air or another fluid through the device, i.e., choosing the arrangement of the prime number of acoustic metamaterial cells and their respective time delays to be applied so as to maximise the noise reduction whilst minimising obstruction/degradation of the flow transmission through the device.

For instance, in general, designing a device substantially as described herein may comprise determining one or more frequencies of noise to be reduced and selecting a desired arrangement of acoustic metamaterial cells to provide noise reduction at the determined one or more frequencies. In preferred embodiments, selecting the desired arrangement comprises selecting a prime number of cells.

As will be appreciated, control over noise reduction may increase with increasing the number of cells. For a relatively higher number of cells (e.g. five or greater), the benefit of having a prime number may become increasingly important.

In addition to the ‘main’ flow passage (e.g. the flow passage around which the acoustic metamaterial cells are arranged, in embodiments where that is the case), the device may comprise one or more further, secondary flow passages. Preferably these further flow passages are also open to allow air or another fluid to flow from one side of the device to the other directly through the further flow passages, e.g. without delay or restriction, in the same way as the main flow passage described above. The further flow passages thus preferably also define a flow path that is parallel to the device axis.

For example, in the case where a plurality of acoustic metamaterial cells are arranged circumferentially around a central flow passage, with the acoustic metamaterial cells being arranged at respective circumferential positons, there may then be further (outer) flow passages provided by the gaps between respective acoustic metamaterial cells at adjacent circumferential positions. In that case, the further flow passages are therefore also arranged radially outwardly and circumferentially around the central flow passage. This helps contribute to an overall increased openness of the device therefore again increasing flow through the device.

As will be appreciated, when an acoustic wave propagating through air or another fluid is incident on the device comprising one or more further, secondary flow passages, a further portion of the acoustic wave propagates through the one or more further, secondary flow passages. The further portion of the acoustic wave may, and preferably will, propagates through the one or more further, secondary flow passages in substantially the same amount of time as that of the first portion propagating through the main flow passage (i.e., also without delay or restriction), such that the (second) portion of the acoustic wave propagating through the one or more acoustic metamaterial cells is thereby also being delayed relative to the further portion of the wave. Accordingly, the further portion and second portion of the acoustic wave will also destructively interfere to provide noise reduction at one or more frequencies based on the respective time delays associated with the one or more acoustic metamaterial cells, in the same manner as the first and second portions described above.

Other arrangements of the acoustic metamaterial cells relative to the flow passage would be possible.

For example, in some embodiments there may be a single acoustic metamaterial cell. In that case this might be a single cell at a single circumferential position. In a preferred embodiment however there may be a single cell that is extended/rotated circumferentially around a central flow passage, such that the single cell bounds the flow passage. The single cell may be formed of unitary construction but for manufacturing ease may in some embodiments be formed from two or more part (e.g. semi) circular pieces that clip or otherwise attach together to form a single cell. Similarly, the two parts may define two cells that each extend part way around the circumference of the central flow passage, but with a circumferential gap between the parts. Various arrangements would be possible in this regard. In such embodiments, where a acoustic metamaterial cell extends circumferentially around a central flow passage, the device may essentially function as a diverging lens (with respect to an incident acoustic wave). This may be because the flow passage at the centre of the device will introduce substantially no time delay to a first portion of an incident acoustic wave propagating therethrough, whereas the single cell rotated around the circumference introduces a time delay to a second portion of the incident acoustic wave (circumferentially surrounding the first portion) propagating therethrough. This therefore creates an inverse parabolic delay profile that acts to disperse acoustic waves, thereby further contributing to the noise reduction effect.

In still other embodiments, rather than, or in addition to, the acoustic metamaterial cells being arranged around the outside of a central flow passage, an annular flow passage may be provide that surrounds one or more of the acoustic metamaterial cells. Thus, in embodiments, the device may further comprise an annular flow passage surrounding at least one acoustic metamaterial cell, the annular flow passage being open to allow air or another fluid to flow through the annular flow passage preferably without restriction such that when an acoustic wave propagating in the air or fluid is incident on the device, a first portion of the acoustic wave propagates through the annular flow passage and a second portion of the acoustic wave propagates through the one or more acoustic metamaterial cells, the first and second portions of the acoustic wave destructively interfering to provide noise reduction at one or more frequencies based on the respective time delays associated with the one or more acoustic metamaterial cells.

Preferably the (central) flow passage has a relatively larger cross-sectional area (perpendicular to the primary flow direction) than any one of the acoustic metamaterial cells. This helps contribute to a more open device. The (central) flow passage preferably has a different cross-sectional shape and/or area to the respective shape/area of any one of the acoustic metamaterial cells. For example, the acoustic metamaterial cells in a preferred embodiment may each present a substantially rectangular (e.g. square) cross section, whereas the central flow passage presents a (e.g.) pentagonal or hexagonal (or other polygon) depending on the number of acoustic metamaterial cells that are arranged circumferentially around the flow passage. In preferred embodiments the totality of the flow passages (e.g. the central flow passage in addition to any further outer flow passages) present a different and preferably greater cross-sectional area (perpendicular to the primary flow direction) than the totality of the acoustic metamaterial cells. That is, the device is preferably relatively open such that the portion of the acoustic wave (and flow) that passes directly through the device, e.g. without restriction or delay, is greater than the portion of the acoustic wave (and flow) that passes through the acoustic metamaterial cells.

Subject to the requirements of the technology described herein, the acoustic metamaterial cells may take various suitable forms as desired. For instance, as explained above, the acoustic metamaterial cells of the present invention comprise an internal channel that extends between the inlet and outlet openings on respective first and second, different sides of the acoustic metamaterial cell to provide a flow path through the cell. However, the internal channel is preferably structured, and the interactions of the incident acoustic waves with the structure of the internal channel may increase the effective path length for the acoustic waves travelling through the cell, and thereby introduce a respective time delay based on this structure. Particularly, the acoustic metamaterial cells may each comprise a collection of structures with which the incident acoustic wave is caused to interact, with the size of the structures typically being smaller than the wavelength of the incident acoustic wave.

For example, the internal channel may have a substantially labyrinthine or meandered structure that determines the respective time delay for the acoustic metamaterial cell. To this end, the acoustic metamaterial cell may comprise one or more ‘bars’ or extrusions that extend into the internal channel to define the tortuous flow path. Preferably, a respective set of one or more bars or extrusions extend into the internal channel from two different (e.g. opposing) sides of the cell to define a meandered structure. Other arrangements would however be possible.

The flow path through the acoustic metamaterial cell may generally develop either parallel or perpendicularly to the primary flow direction. For instance, in some embodiments, the bars or extrusions that extend into the internal channel to define the tortuous flow path may be substantially perpendicular to the primary flow direction. In that case, fluid passing through the internal channel will be caused to follow a tortuous path that on average flows between the inlet and outlet openings in the primary flow direction, along the device axis. In other words, the tortuous path may meander along the device axis, in the primary flow direction. In other embodiments however the bars or extrusions may be substantially parallel to the primary flow direction. In that case, the tortuous path may meander perpendicularly to the device axis, in the circumferential or radial direction, such that fluid flows through the acoustic metamaterial cell on average in the circumferential or radial direction. Various arrangements would be possible in this regard.

In embodiments there may be a uniform spacing between adjacent ones of the bars or extrusions that define the tortuous path. That is, bars or extrusions may define a regular or uniform meander with a constant radius of curvature. In some preferred embodiments however there may be a non-uniform spacing between adjacent ones of the bars or extrusions that define the tortuous path. In that case, the spacing preferably increases in the primary flow direction such that fluid is allowed to expand as it flows through the internal channel of the acoustic metamaterial cell. This can help better control the flow boundary when the fluid exits the acoustic metamaterial cell and merges with the fluid that has passed through the flow passage, and can result in a smoother flow transition, and improved flow characteristics. This can also help with impedance matching the cells to the flow passage which can in turn increase the acoustic transmissivity of the acoustic metamaterial cells. Thus, this can also improve the noise reduction performance of the device.

In some embodiments the bars or extrusions defining the tortuous path are straight and preferably extend at right angles into the internal channel. However, in other preferred embodiments the bars or extrusions may be curved or not straight and/or may extend into the internal channel at different angles (e.g. not at right angles). Thus, the distance between adjacent bars or extrusions may vary along the length of the bar or extrusion, due to there being a curved, slanted, or otherwise not parallel relationship between adjacent bars or extrusions. Again, this can help better control the flow or pressure gradient within the acoustic metamaterial cell which can help control the flow characteristics (and in turn also the acoustic transmissivity).

The bars or extrusions defining the tortuous path may all extend into the channel the same distance, i.e. they may have the same length. In other embodiments however the bars or extrusions may have different lengths. Likewise, the bars or extrusions may have the same or different thicknesses.

In these respects, it will be appreciated that this construction of acoustic metamaterial cell is particularly beneficial for use with in-line flow arrangements as the acoustic metamaterial cells also transmit the flow, and can further be structured to control the flow through the internal channel to provide improved flow characteristics. Thus, the acoustic metamaterial cells of the technology described herein can beneficially simultaneously control the delays that are introduced to acoustic waves propagating in the fluid (in order to provide the desired interference) and also the characteristics of the flow itself, to provide an overall improved device performance.

Preferably each acoustic metamaterial cell presents a substantially rectangular (e.g. square) cross section (perpendicular to the primary flow direction). In that case, the inlet/outlet openings are preferably relatively narrower rectangular slits opening on respective sides of the acoustic metamaterial cell. For example, the openings may comprise between about 5% to 50% of the area of the side of the acoustic metamaterial cell, or in embodiments between about 5% and 25%, or 5% and 15% of the area of the side of the acoustic metamaterial cell. As mentioned above, the inlet and outlet openings are preferably provided on opposite sides of the cell such that the openings are axially spaced apart in the primary flow direction. Thus, the inlet opening is preferably provided on the upstream face of the cell relative to the primary flow direction, preferably coterminous with the opening to the flow passage (and preferably perpendicular to the primary flow direction).

The inlet and outlet openings may be aligned with each other or may be offset from one another in the circumferential direction. Various arrangements would be possible in this regard.

The acoustic metamaterial cells may comprise a three dimensional shape comprising a rectangular cuboid, or a geometry other than a rectangular cuboid, such as a cylinder; a rhombohedron; or a polygonal prism, such as a triangular, hexagonal, pentagonal, or trapezoidal prism. Other three dimensional shapes are of course possible. For instance, the one or more of the acoustic metamaterial cells may additionally or alternatively comprise a three dimensional shape defined by a rectangle (or other two-dimensional geometry) extruded along a curved path, such as along at least a portion of a circle, e.g., so as to define at least a portion of a cylindrical perimeter of the first noise reduction assembly. In embodiments comprising a plurality of acoustic metamaterial cells, different ones of the acoustic metamaterial cells may comprise different ones of the aforementioned shapes.

In some cases where the acoustic metamaterial cells are designed to be inserted into a grid structure, the cells may be open on one or more sides such that the cells are closed by the grid structure (or, e.g., by an interior surface of the device or conduit within which the device is mounted). Various arrangements would be possible in this regard.

The acoustic metamaterial cells in some preferred embodiments are substantially cuboidal having at least one rectangular (e.g. square) face. In that case, the first side of the acoustic metamaterial cell may be a side of the rectangular cuboid, and the second side of the acoustic metamaterial cell may be an opposing side of the rectangular cuboid to the first side.

The cells may generally be in the form of a rectangular cuboid with a square base shape of side Δ₀/2 and height of Δ₀, where Δ₀ is a desired operating wavelength. In this respect, it has been found that it may be advantageous to keep the size of the cells (e.g. in the plane of the device) smaller than the wavelength corresponding to the Nyquist frequency. Thus, when designing a device that is optimised or configured for use at an operating wavelength, Δ₀, the acoustic metamaterial cells may suitably have a dimension of Δ₀/2, or smaller.

Other arrangements would be possible and the acoustic metamaterial cells may generally have any suitable and desired shapes and/or sizes.

The discussion so far has related to a single device that preferably comprises one or more acoustic metamaterial cells at a single plane. However, it will be appreciated that the device may in embodiments comprise multiple such devices arranged in combination to provide improved noise reduction. Providing multiple such devices, with potentially different arrangements of acoustic metamaterial cells, can allow to extend the performance of the device. For example, as described above, the delays introduced by the respective cells will generally be designed or optimised for noise reduction at certain selected frequencies. Providing multiple such devices that are designed to reduce noise at different frequencies can therefore effectively extend the frequency operation range of the device.

Thus, in embodiments, the one or more acoustic metamaterial cells define a first noise reducing assembly, and the device further comprises a second noise reducing assembly. The first and second noise reducing assemblies are preferably axially spaced apart from the first noise reducing assembly in the primary flow direction.

For instance, as mentioned above, in preferred embodiments, a plurality of acoustic metamaterial cells are provided at the same axial position, in a substantially planar arrangement. These cells may define a first noise reducing assembly that is therefore associated with a first axial position. A corresponding second noise reducing assembly can then be provided at a second, different axial position. Preferably the second noise reduction assembly is also substantially planar and parallel to the first noise reducing assembly.

In preferred embodiments the first and second noise reducing assemblies both comprise similar assemblies of acoustic metamaterial acoustic metamaterial cells (i.e. they are effectively two of the devices described herein provided in series). In that case, the first and second noise reducing assemblies could be substantially identical. However, it is preferred that the first and second noise reducing assemblies contain different arrangements of acoustic metamaterial cells to provide an extended noise control function. For example, the first and second noise reducing assemblies may contain different types of cells and/or different numbers of arrangements of cells.

In other embodiments the device (i.e. the first noise reducing assembly) may be used with another type of device, e.g. one that does not use the acoustic metamaterial cells of the technology described herein. For example, the first noise reducing assembly may be a device of the type described herein whereas the second noise reducing assembly is a more conventional resonant cavity based silencer. However, it is generally preferred that both assemblies are devices of the type described herein as more conventional resonant cavity based silencers may not offer the improved flow characteristics of the devices described herein.

Providing two or more noise reducing assemblies (or, devices) in series also offers further opportunities for tuning the performance of the device (system). For example, the mutual positioning between the noise reducing assemblies can be selected in order to control the interactions between the assemblies, both in terms of the flow and the propagation of acoustic waves.

In this respect, it will be appreciated that the delay based approach of the technology described herein is particularly powerful since delays are generally additive so introducing different delays at different positions can provide enhanced possibilities for manipulating acoustic waves. Various examples of this are described in WO 2018/146489 or WO 2020/208380, both filed in the name of The University of Sussex, and the contents of which are incorporated herein in their entirety.

The mutual positioning of the assemblies is therefore another design parameter that can be used to control the performance of the device. In embodiments the device may be pre-configured and then fixed in place, e.g. in an optimised arrangement for a particular application. This may be appropriate for larger scale installations. However, in some cases it may be desirable for a local user (or technician) to be able to adjust the device in use to tailor the noise reduction. Thus, in embodiments, the first and second noise reducing assemblies can be rotated or otherwise moved relative to one another to selectively control the noise reduction function of the device. For example, the relative positions of the assemblies may be adjusted in order to control which frequencies of noise are attenuated.

As alluded above, another benefit of the time delay based approach described herein is that the delay distribution across the overall device can be tailored to perform additional manipulations of the acoustic waves. This is in contrast for example to quarter-wavelength based resonators which do not allow such flexibility. For example, in a previous application, WO 2018/146489 (The University of Sussex), it was described how the phase delay distribution for a set of plural cells could be selected to produce a desired acoustic field, with a desired precision, by quantising the field and mapping the quantised values to a suitable arrangement of cells delays. A similar approach can be applied to the arrangements of the acoustic metamaterial cells within the devices of the technology described herein.

For instance, one possibility in this regard would be to provide a device having an arrangement of acoustic metamaterial cells that is configured to act as a dispersive lens. In that case, incident acoustic waves at least at a designed operating frequency may thus be dispersed as they pass through the device, which can help further attenuate noise. A simple example of this would be when there is a single annular acoustic metamaterial cell that extends entirely around a central flow passage. However, various more complex geometries are also envisaged. Similarly, the devices described herein may be used in combination with a dispersive lens or other arrangement of metamaterial cells to enhance the noise reduction and/or to further manipulate the acoustic waves in a desired manner.

Thus, in embodiments, the one or more acoustic metamaterial cells are configured to act as a dispersive lens and/or wherein a dispersive lens is provided within the device.

The device, and the acoustic metamaterial cells, may be manufactured in any suitable manner as desired. For example, the device and/or acoustic metamaterial cells may generally be manufactured according to any of the techniques described in WO 2018/146489 or WO 2020/208380, both filed in the name of The University of Sussex, and the contents of which are incorporated herein in their entirety. For example, in some embodiments, the device may be formed by additive manufacturing (e.g. 3D printing), or by injection moulding.

In some cases the device may be formed as a unitary structure. In other preferred embodiments, however, the device is provided of modular construction such that a user (or technician during installation) can readily re-configure the device by suitably selecting which acoustic metamaterial cells are provided at which positions within a suitable grid structure for the device. For instance, the device may comprise a grid structure comprising one or more, and preferably a plurality of, grid openings into which respective acoustic metamaterial cells can be inserted.

A kit of parts may thus be provided comprising a grid structure comprising one or more grid elements, each grid element being configured to receive a respective acoustic metamaterial cell; and a set of one or more acoustic metamaterial cells that can be inserted into the respective grid elements to provide a device substantially as described herein. For example, the grid structure may comprise a plurality of grid elements and a plurality of acoustic metamaterial cells that can be inserted into the respective grid elements to construct the device described above. Preferably the kit comprises at least some acoustic metamaterial cells of different types to allow user (re-)configurability of the device. For instance, the user may selectively use less than all of the acoustic metamaterial cells, or may use different types of acoustic metamaterial cells, in order to control or adjust the performance of the device.

The acoustic metamaterial cells, and generally the device, may be formed from any suitable material as desired. Suitable materials may include, for example, plastics (thermoplastics), metals, rubber. In general, any material may be used so long as it is suitable for the intended application of the device. Indeed, a benefit of the acoustic metamaterial approaches described herein is that the acoustic metamaterial cells can generally be fabricated from any suitable material since the noise reducing effect depends on the structure of the cells rather than the material properties per se.

As mentioned above, the device may be re-configurable. For instance, in embodiments, the device can be manually re-configured by a user manually selecting which acoustic metamaterial cells to use at which positions, e.g. within a grid structure for the device. In that case, the acoustic metamaterial cells may themselves be essentially fixed but the device may be re-configured by using different combinations or arrangements of acoustic metamaterial cells.

It is also contemplated however that the acoustic metamaterial cells may themselves be re-configurable. For example, the acoustic metamaterial cells may be re-configurable to adjust the size and/or form of the internal channel within the acoustic metamaterial cell, to thereby adjust the associated delay. Various arrangements would be possible in this regard. For instance, in some embodiments, the side walls of the acoustic metamaterial cells from which the bars or extrusions extend may be slidable or otherwise movable relative to one another in order to effectively increase or decrease the distance into the internal channel that the bars or extrusions extend and thereby adjust the length of the tortuous flow path. In other embodiments the bars or extrusions may comprise flaps that can be selectively raised or lowered to adjust the tortuous flow path. Various examples are contemplated in this regard in WO 2018/146489 (The University of Sussex).

Thus, in embodiments, the device may be provided of modular construction such that a user (or technician during installation) can readily re-configure the device by suitably selecting and adjusting the internal size of one or more acoustic metamaterial cells. For instance, a first device portion may provide a first set of one or more bars or extrusions, a second device portion may provide a second set of one or more bars or extrusions, wherein, in use, the first device portion is configured to slidably engage with the second device portion to provide the one or more acoustic metamaterial cells. That is, when the first and second device portions are configured to be slidably engaged, the first and second sets of one or more bars or extrusions are configured to be staggered with respect to one another and to extend into the internal channel from two different (e.g. opposing) sides of the cell to define a meandered structure. The first and second device portions may be slid with respect to each other (e.g. in opposing directions) such that they remain engaged (i.e. such that the one or more acoustic metamaterial cells are still provided), but result in an altered internal volume of the meandered structure (e.g. increasing or decreasing the volume when the first and second device portions are slid away from each other and towards each other, respectfully).

Additionally or alternatively, the device may provide the one or more acoustic metamaterial cells which are fixed in size, and, for each of the one or more acoustic metamaterial cells, a first cell portion may provide a first set of one or more bars or extrusions and/or a second cell portion may provide a second set of one or more bars or extrusions, wherein the first and/or second cell portions may be moved relative to the respective acoustic metamaterial cell so as to change the amount the respective sets of one or more bars or extrusions extend into the internal channel of the cell to define an adjustable meandered structure.

In other embodiments, rather than adjusting the acoustic metamaterial cells, or the arrangement thereof, the device may be adjusted in other ways. For instance, it was contemplated above that two such devices could be provided which are movable relative to one another in order to adjust the function of the device. In a similar fashion, the device may further comprise a masking element that is rotatable or otherwise movable relative to the arrangement of acoustic metamaterial cells. For instance, the mask may be configured to adjustably at least partially cover an inlet opening or outlet opening of at least one of the acoustic metamaterial cells. In this way, the mask can be used to selectively adjust the proportions of the flow that pass through the flow passages relative to the acoustic metamaterial cells, for example. Various other arrangements would be possible in this regard.

The (internal) surfaces of the acoustic metamaterial cells may be substantially smooth to minimise interactions between the flow and the surfaces of the acoustic metamaterial cells. However, in some cases, it may in fact be desirable to introduce a certain surface roughness at least to the surfaces of the acoustic metamaterial cells that define the tortuous flow path. In this respect, the inventors recognise that increasing the surface roughness will impact the flow (by changing the boundary conditions), and thus provides a further mechanism for controlling the interaction of the incident flow with the acoustic metamaterial cells. For instance, by increasing the surface roughness, turbulent flow may be induced inside the acoustic metamaterial cells, which can further dissipate noise.

As explained above, the device of the technology described herein is preferably used for in-line flow arrangements. For example, the devices of the technology described herein may find particularly utility in the context of HVAC systems, other similar in-line flow applications such as water coolers to attenuate noise associated with a water pump, or oil circuits. In such cases, the device is preferably installed within or connected to a flow conduit (e.g. pipe) associated with such systems.

The device may be provided within existing flow conduit, or may be provided as standalone unit (e.g. a section of piping) that can be interconnected with existing piping. Various arrangements possible in this regard. Similar applications would be for reducing noise associated with fans located inside, e.g., computer cabinets, cabinets for housing domestic appliances, etc., where there is no extended piping as such but wherein there is a directional flow due to the fan.

Thus, in another aspect, there is provided apparatus comprising: a fan or pump; a flow conduit for channelling air or another fluid from the fan or pump to an exhaust outlet; and a device substantially as described herein installed within or otherwise connected to the flow conduit for attenuating noise associated with the fan or pump.

Other applications are however also contemplated and in general the device may be used for any application where improved noise control may be desired. For example, it is also contemplated that the devices may be used for musical instruments, e.g. within a sound hole of an acoustic guitar, or as a muffler (or mute) for a trumpet, etc.

The use of acoustic metamaterial cell arrangements according to the technology described herein may thus provide highly effective noise reduction whilst still allowing significant flow throughput as the flow is able to pass not only through the open flow passage(s) formed in the device but also passes through the acoustic metamaterial cells.

The use of acoustic metamaterial cells as described herein also provides further possibilities for manipulating both the acoustic waves and the flow in order to provide improved control over both the noise reduction performance and the flow performance. A more flexible construction can also be realised as the acoustic metamaterial cells can easily be tailored for a particular application of interest.

The technology described herein may therefore provide various benefits compared to other possible approaches.

### BRIEF DESCRIPTION OF THE DRAWINGS

Various embodiments of the technology described herein will now be described by way of example only and with reference to the accompanying figures, in which:

FIGS. 1A and 1B show a device according to an embodiment of the technology described herein.

FIGS. 2A-2F show various examples of acoustic metamaterial cells that may be used in accordance with embodiments of the technology described herein.

FIGS. 3A-3E illustrate how different combinations of acoustic metamaterial cells may be used to tailor the operation of a device according to an embodiment of the technology described herein.

FIGS. 4A and 4B illustrate a modular construction of a device according to an embodiment of the technology described herein.

FIGS. 5A-5D show how multiple devices may be combined in series according to embodiments of the technology described herein.

FIGS. 6A-6D show a device according to another embodiment of the technology described herein.

FIGS. 7A-7D show another example of a device.

Like reference signs are used to denote like components in the figures.

### DETAILED DESCRIPTION

Various non-limiting examples and embodiments will now be described to help illustrate these concepts.

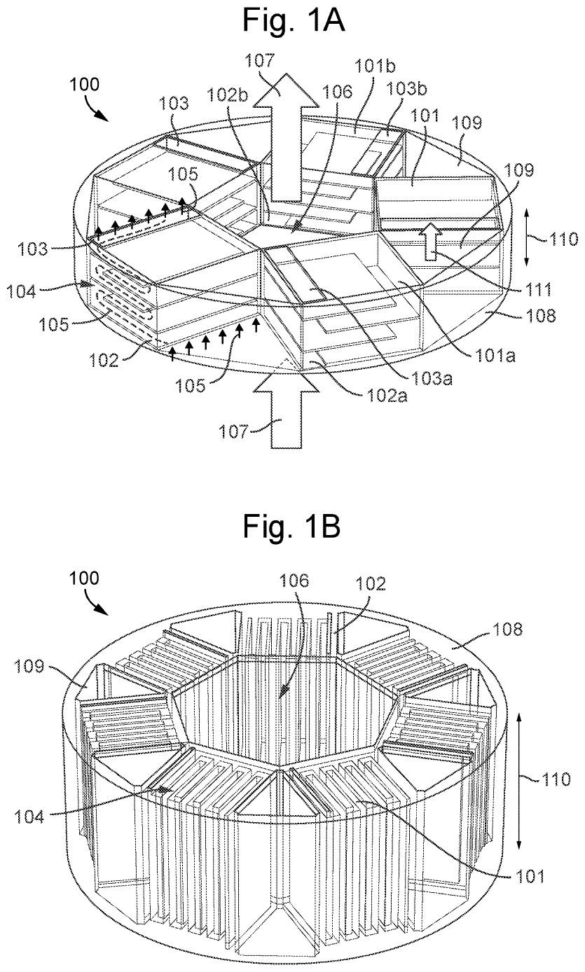

FIGS. 1A and 1B show schematically a device 100 for controlling noise, according to embodiments of the technology described herein.

In FIG. 1A, the device 100 includes five acoustic metamaterial cells 101. Each metamaterial cell 101 has an inlet opening 102 on a first side of the acoustic metamaterial cell 101 and an outlet opening 103 on a second (different) side of the acoustic metamaterial cell 101. In FIG. 1A, for clarity, only a selected number of the various features are labelled. Each metamaterial cell 101 defines an internal channel 104 therein which extends between the inlet opening 102 and the outlet opening 103. Accordingly, air or another fluid (that is, generally any fluid) is able to flow into the inlet opening 102, through the internal channel 104 and out of the outlet opening 103, as indicated generally by the smaller arrows and dashed line which traces a tortuous flow path 105. Accordingly, each one of the acoustic metamaterial cells 101 is structured such that the respective internal channel 104 for the acoustic metamaterial cell 101 provides a tortuous path 105 through the acoustic metamaterial cell 101. The acoustic metamaterial cells 101 are arranged relative to a flow passage 106 that is open to allow air or another fluid to flow through the flow passage 106 in a primary flow direction without restriction, as indicated generally by the larger arrows which show unrestricted flow 107. It will be understood that “without restriction” means without obstacles or barriers being present in the flow direction 107, such that the flow 107 follows a substantially straight line (as shown in FIG. 1A). That is, the flow 107 is only restricted in directions perpendicular to the flow direction, and substantially the only restriction to the flow 107 exerted by the device 100 on the flow 107 is the frictional resistance at the interface of the flow 107 and the walls of the flow passage 106. In FIG. 1A, the device 100 extends in an axial direction 110, and the flow passage 106 extends as a pentagonal prism in the axial direction 110 such that there is no restriction to the flow in the axial direction 110.

The acoustic metamaterial cells 101 are shown here as brick-like structures, as will be discussed in greater detail below.

The acoustic metamaterial cells 101 are arranged circumferentially around the flow passage 106, such that the flow passage 106 is an inner (e.g., central) flow passage 106. In embodiments, the central flow passage 106 is delimited by the circumferentially arranged acoustic metamaterial cells 101, such that a side of each acoustic metamaterial cell provides an inner facing surface of the central flow passage 106. Given that there are five brick-like acoustic metamaterial cells 101 in the device 100 of FIG. 1A, the central flow passage 106 has a pentagonal prism shape extending in the axial direction 110. However, as will be understood, the central flow passage 106 may have a different shape. For instance, in the device 100 according to the embodiment of FIG. 1B, there are seven brick-like acoustic metamaterial cells 101, such that the central flow passage 106 has a heptagonal prism shape extending in the axial direction 110. In other embodiments, the central flow passage may have a different regular or irregular polygonal prism shape.

As can be seen from FIGS. 1A and 1B, the inlet openings 102 and outlet openings 103 are orientated so as to be open to the flow in a similar manner as the flow passage 106. That is, the openings 102 and 103 are each in a plane which is parallel with the respective opening and outlet of the flow passage 106. In FIGS. 1A and 1B, the openings 102 and 103 are orientated so as to each be in the same plane as that defined by the respective opening and outlet of the flow passage 106. However, in other embodiments, the openings 102 and 103 may be each in a plane which is parallel with the respective opening and outlet of the flow passage 106, but not necessarily the same respective planes. For instance, although not shown, in some embodiments one or more of the acoustic metamaterial cells 101 may be staggered with respect to others of the acoustic metamaterial cells along the axial direction. The acoustic metamaterial cells 101 having inlet 102 and outlet 103 openings which are open to the general flow direction through the device 100 as discussed may minimise or reduce the restriction or resistance to the flow through the device 100, for instance as compared to if the cells were to be closed in the flow direction and instead having an inlet opening orientated to be open perpendicular to the flow direction.

As will be understood, if an acoustic wave is incident on the device 100, the tortuous path 105 will result in the portion of the acoustic wave propagating through the cell 101 will gain a time delay with respect to the portion of the acoustic wave propagating through the flow passage 106. Accordingly, the internal channel 104 of the cells 101 can be designed for certain frequencies such that the portion of the wave emitted from the outlet opening 103 destructively interferes with the portion emitted from the outlet of the flow passage, thereby reducing the noise propagating from one side of the device 100 (be it upstream or downstream of the device with respect to the flow conditions) to the other side of the device 100.

Referring to FIGS. 1A and 1B, the device 100 has an outer housing 108. In the embodiments shown, the device 100 is substantially cylindrical. That is, the outer housing 108 of the device 100 is an outer cylindrical housing 108.

In FIG. 1A, a side of each of the acoustic metamaterial cells 101 is adjacent to and radially inside of the outer cylindrical housing 108. Alternatively, as shown in FIG. 1B, a side of each of the acoustic metamaterial cells 101 may be integral with the outer cylindrical housing 108 (i.e., the acoustic metamaterial cells 101 each provide a portion of the outer cylindrical housing 108).

In FIGS. 1A and 1B, the device 100 also includes further flow passages 109, which are positioned between adjacent acoustic metamaterial cells 101 so as to also be arranged circumferentially around the central flow passage 106. Accordingly, in FIG. 1A there are five further flow passages 109, whereas in FIG. 1B (which shows seven acoustic metamaterial cells 101) there are seven further flow passages 109. The further flow passages 109 are also open to allow air or another fluid to flow through the flow passage 109 without restriction in the primary flow direction, as indicated generally by the medium solid white arrow which shows unrestricted further flow 111. Although not specifically shown, in various embodiments there may be additional flow passages positioned elsewhere, for instance between the radially outer side of one or more of the acoustic metamaterial cells 101 and the outer housing 108.

As will be appreciated, the effective path length of an acoustic wave (or a portion of an acoustic wave) propagating through each of the further flow passages 109 (or indeed any other additional flow passages which may extend without restriction in the axial direction 110) is the same as that of the central flow passage 106, such that these portions may destructively interfere with the portion of an acoustic wave being emitted from the outlet openings 103 of the one or more acoustic metamaterial cells 101 (in a similar manner as described above in reference to the portion of an acoustic wave propagating through the central flow passage 106). In FIGS. 1A and 1B, each of the further flow passages 109 is delimited by the corresponding pair of adjacent acoustic metamaterial cells 101 and a portion of the outer cylindrical housing 108, such that each further flow passage has a triangular prism shape extending in the axial direction 110.

Referring to FIG. 1B, the device 100 includes seven acoustic metamaterial cells 101, as opposed to five as shown in FIG. 1A. As discussed above, having a prime number may be beneficial.

The acoustic metamaterial cells may not all be identical, as will be discussed in greater detail below. For instance, in FIG. 1A, the inlet opening 102a and outlet opening 103a of at least one acoustic metamaterial cell 101a may be aligned in the axial direction 110, whereas in contrast the inlet opening 102b and outlet opening 103b of at least one acoustic metamaterial cell 101b may not be aligned in the axial direction 110. This may additionally help reduce the associated symmetries of the device, resulting in fewer available (and more robust, i.e. further isolated) associated eigenmodes of the system For instance, the outlet openings 103 shown on the upper surface of FIG. 1A are relatively positioned on the same side of the respective acoustic metamaterial cell 101, such that the ensemble of the outlet openings 103 has an order 5 rotational symmetry. In contrast, the inlet openings 102 are not relatively positioned on the same side for all respective acoustic metamaterial cells 101 (e.g., compare acoustic metamaterial cell 101a with 101b), such that the ensemble of the inlet openings 102 has no rotational symmetry. It will also be appreciated that in the specific embodiment of FIG. 1A, the internal channel 104 in the acoustic metamaterial cell 101a has a shorter effective path length as compared to that of the acoustic metamaterial cell 101b, such that the associated acoustic time delay between the two acoustic metamaterial cells 101a, 101b differ. Accordingly, different acoustic cells may impart different time delays at different positions of the device. However, the inventors have further discovered that placing inlet openings 102 and/or outlet openings 103 at different relative positions for the acoustic metamaterial cells affords further control over the total flow dynamics through the device 100. For instance, more or less turbulence may be imparted to the downstream flow as compared to the upstream flow, or an upstream substantially laminar flow may be converted into downstream turbulent flow or torsional flow (or vice versa). That is, embodiments of the technology described herein enable control over both: (i) noise reduction at a range of desirable frequencies; and (ii) the specific flow dynamics of the air or another fluid flowing through the device. For instance, in some embodiments, the flow going through the device may be maximised, e.g., by affecting the generation of high-frequency noise through vortex shedding.

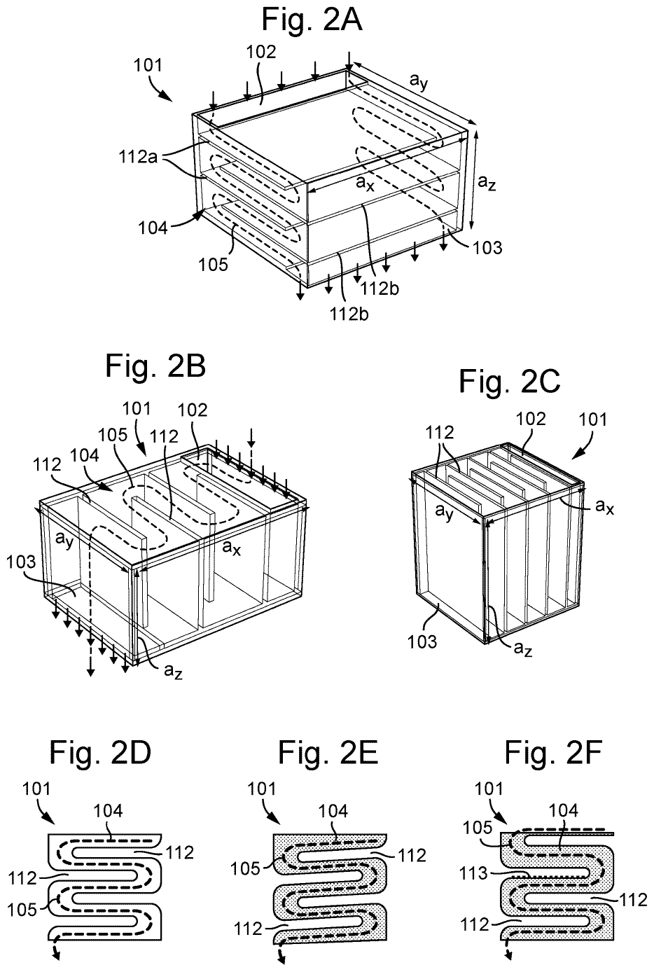

Referring again to FIG. 1B, the upper surfaces of each acoustic metamaterial cell 101 are shown transparent, to clearly show the specific form of the internal channel 104 therein, which differs to that shown in FIG. 1A and will be discussed in more detail below in reference to FIGS. 2A-2C.

FIGS. 2A-2C show schematically an acoustic metamaterial cell 101 for use within a device 100 for controlling noise, according to embodiments of the technology described herein. The acoustic metamaterial cell 101 of each of FIGS. 2A-2C are each cuboidal in shape, having a length direction aₓ, a width direction a_{y}, and a depth direction a_{z} (which will be parallel to the axial direction 110 when the cell 101 is provided in the device 100). Accordingly, when provided within the device 100, the cell 101 may be orientated in any desirably rotation about the depth direction a_{z}, however the depth direction a_{z} is always provided parallel to the axial direction 110 such that the planes defined by the inlet 102 and outlet 103 openings remain perpendicular to the primary flow direction (i.e. the direction indicated by arrows 107 and 109 in FIG. 1A).

FIG. 2A shows a cuboidal acoustic metamaterial cell 101 similar to cell 101b shown in FIG. 1A. The inlet opening 102 extends substantially the entire way across the cell 101 in the length direction aₓ, and partly across the cell 101 in the width direction a_{y}, so as to be a slot opening. The internal channel 104 of the cell 101, which provides the tortuous path 105 therethrough, is formed by staggered extrusions 112, as shown. The extrusions 112 are substantially planar walls parallel to the aₓ-a_{y} plane and extending the full length of the cell 101 in the length direction aₓ, but not entirely extending the full width of the cell 101 in the width direction a_{y} (and have a relatively thin thickness in the depth direction a_{z}). A first set 112b of extrusions 112 partially extend from one distal side of the cell 101 in the width direction a_{y}, and a second set 112b of extrusions 112 partially extend from the other distal side of the cell 101 in the width direction a_{y}. The first 112a and second 112b sets are staggered so as to define the internal channel therebetween. In FIG. 2A, the first set 112b comprises two extrusions and the second set 112b also comprises two extrusions. In contrast, the cell 101b in the device 100 of FIG. 1A has a first set 112b comprising two extrusions whereas the second set 112b comprises three extrusions.

Turning now to FIGS. 2B and 2C, there is shown alternative cuboidal acoustic metamaterial cells 101 wherein the extrusions 112 are orientated so as to be parallel to the a_{y}-a_{z} plane, which is similar to the cells shown in the device 100 of FIG. 1B. The extrusions 112 extend the full length of the cell 101 in the depth direction a_{z}, but not entirely extending the full width of the cell 101 in the width direction a_{y} (and have a relatively thin thickness in the length direction aₓ). The cell 101 of FIG. 2C is provided with a larger number of extrusions relative to the cell 101 of FIG. 2B, such that the effective path length through the cell of FIG. 2C would be longer relative to that of FIG. 2B (provided the cells 101 otherwise have the same outer dimensions in aₓ, a_{y}, a_{z}). As will be appreciated, the cells 101 of FIGS. 2B and 2C may be simpler to manufacture via injection moulding than the cell 101 of FIG. 2A due to the relative orientations of the extrusions 122, however the size of the openings (in the length direction aₓ) in FIGS. 2B and 2C may be limited by the maximum separation between the distal wall in the length direction ax and the nearest extrusion 112. In contrast, in embodiments having cells 101 similar to FIG. 2A, the inlet openings 102 (and outlet openings 103) have no particular restriction on their size. For instance, in use, the outlet opening 103 may be configured to be larger than the inlet opening 103, such that, if a flow of air or another fluid flows through the device 100, the larger outlet opening 103 may spatially disperse the portion of the flow exiting the cell 101 to minimise, e.g., induced turbulence as it re-joins the unrestricted flow which has passed through the central flow passage 106 (and/or the unrestricted flow 111 which has passed through the further flow passages 109).

FIGS. 2D-2F show cross-sectional views of the extrusions 112 and internal channel 104 of a cell 101, according to various embodiments.

FIG. 2D shows a cross-sectional view of a cell 101 wherein the base of extrusions 112 and distal ends of extrusion 112 which are curved. This may improve the efficiency of a flow along the tortuous path 205 passing through the internal channel 104.

FIG. 2E shows a cross-sectional view of a cell 101 having slanted extrusions 112. This may also improve efficiency of a flow along the tortuous path 205. In embodiments wherein the extrusions 112 flare outwards towards the respective distal end, this may extend the effective path length without having to increase the number of extrusions 112 or the outer dimensions of the cell 101.

FIG. 2F shows a cross-sectional view of a cell 101 having un-equally spaced extrusions 112, such that the internal channel 104 is wider in some portions relative to other portions. As will be understood, changing the gradient spacing of the internal channel 104 will affect the velocity and pressure of a flow at different points along the tortuous path 205 passing through the internal channel 104.

For instance, although not shown, the gradient spacing of the internal channel may be configured so as to increase from the inlet opening 102 to the outlet opening 103 such that a flow exiting the cell 101 may be impedance-matched (or substantially impedance-matched) the unrestricted flow which has passed through the central flow passage 106 (and/or the unrestricted flow 111 which has passed through the further flow passages 109), thereby potentially reducing or minimising refraction of a portion of an acoustic wave propagating through the cell 101 as it exits the cell 101 and impinges on a portion of an acoustic wave which has propagated the central flow passage 106 (and/or which has propagated through the further flow passages 109).

FIG. 2F also shows an extrusions 112 having a rough surface portion 113 (relative to other smoother surfaces of the extrusions 112). As will be understood, a rough surface portion 113 may scatter some frequencies of an acoustic wave impinging thereon. Moreover, a rough surface portion 113 may also enable further control over the flow dynamics through the cell, for instance, by inducing a transition, in high velocity flow, between lamina and turbulent flow.

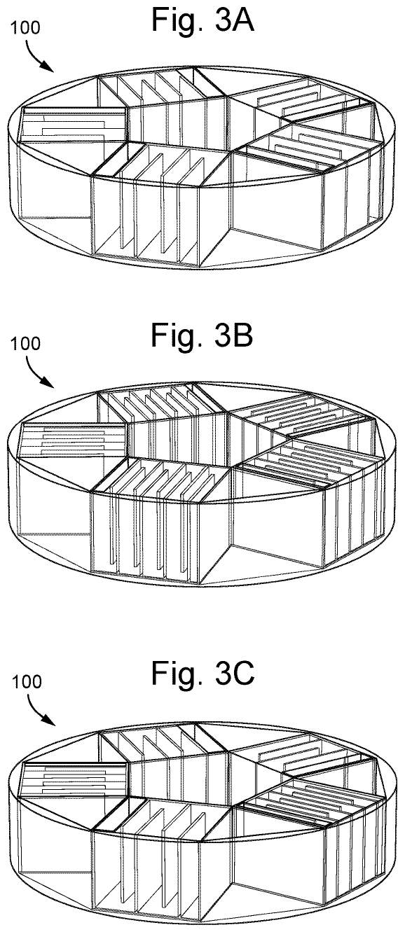

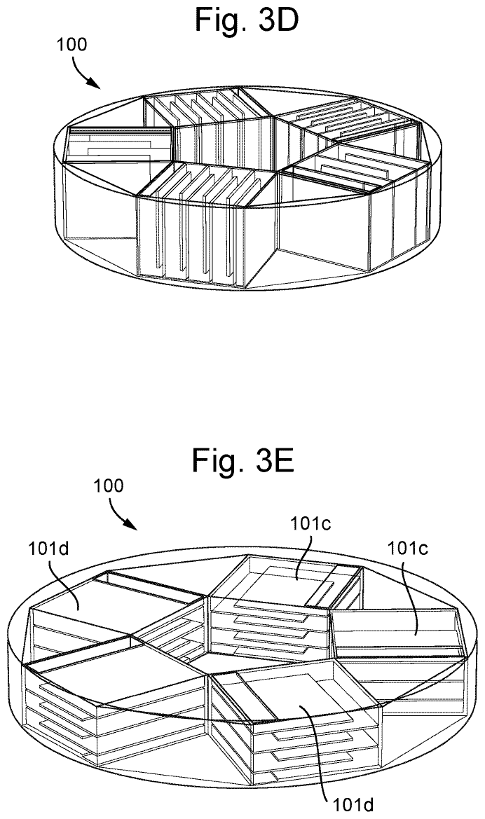

FIGS. 3A-3E shows various devices 100 having different acoustic metamaterial cells 101 or combinations thereof, according to various embodiments. FIG. 3A shows a device 100 similar to FIG. 1A, but with the cells 101 as shown in FIG. 2B. FIG. 3B shows a device 100 similar to FIG. 1A, but with the cells 101 of FIG. 2C. FIGS. 3C and 3D show devices 100 having combinations of the cells 101 of FIGS. 2B and 2C, in different arrangements. FIG. 3E shows a device 100 similar to FIG. 1A, but with cells 101c similar to that shown in FIG. 2A but having a first number of extrusions 112, and cells 101d similar to that shown in FIG. 2A but having a second number of extrusions 112 different to the first number.

Although not shown, the device could of course have combination of cell 101 of FIG. 2A combined with cell 101 of FIGS. 2B and/or 2C (or various combinations with more or less extrusions). As will be appreciated, combining various different types of cell 101 may lead to greater control over the noise reduction capabilities of the device 100

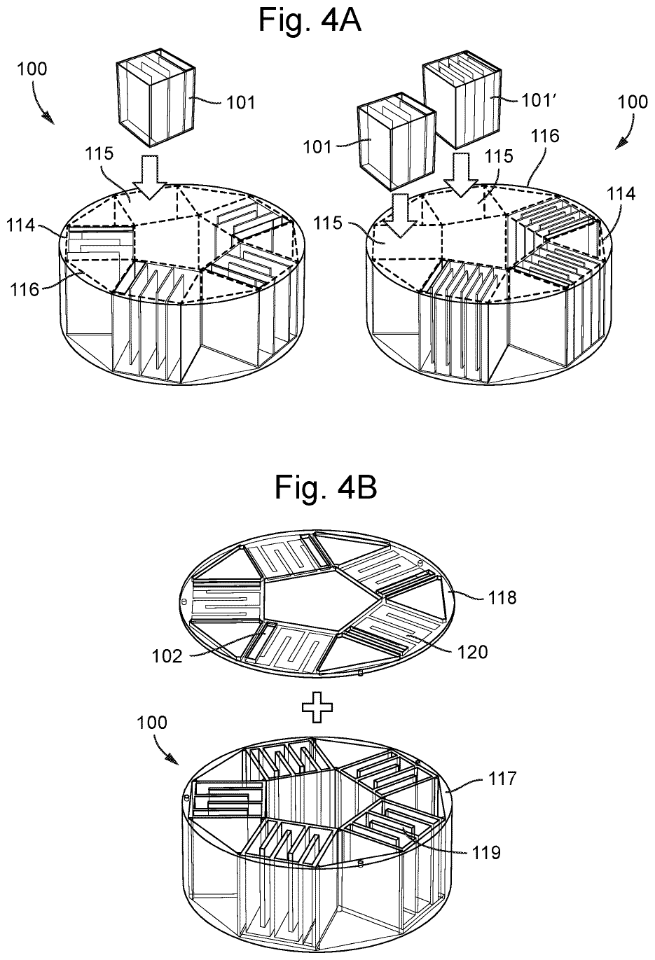

FIG. 4A shows schematically a modular construction of a device 100 which may, as an example, correspond to any of FIGS. 3A-3D, according to an embodiment of the technology described herein. The device 100 includes a grid structure 114, into which acoustic metamaterial cells 101 may be placed. For instance, the grid structure 114 defines one or more cavity retainers 115 (i.e. grid elements) into which cells 101 may be placed either during manufacture or assembly, or during installation or re-configuration by an operator or technician. The grid structure 114 may define the various (one or more) flow passages 106, 109, e.g., by providing the walls of the flow passages 106, 109, or some of the outer surfaces of the cells 101 may define the flow passages 106, 109 once placed into the grid structure 114.

As will be appreciated, a device 100 including a grid structure 114 may be re-configurable so as to adapt to different acoustic noise reduction response requirements or different flow dynamics, e.g., by replacing one particular design of cell 101 with a different design of cell 101 having different acoustic and/or flow dynamic properties, as discussed above and shown in the right hand side of FIG. 4A.

In the embodiments shown, the grid structure 114 has a grid perimeter 116 thereby defining the cylindrical circumference of the device 100. However, in other embodiments (not shown), the grid structure 114 may not include a grid perimeter 116 as shown, e.g., such that a pipe or conduit into which the device 100 is placed may provide the cylindrical circumference (e.g., also defining the further flow passages 109 between adjacent ones of the cells and the inner surface of the pipe or conduit into which the device 100 is placed).

FIG. 4B shows schematically a further modular construction of a device 100, according to an embodiment of the technology described herein. The device 100 includes a body portion 117 and a cap portion 118. The body portion 117 of the device includes body portions 119 of cells 101, wherein each cell body portion 119 includes the various structural features of the cell 101 (e.g., outlet opening 103, internal channel 104, etc.) but does not include the upper surface including the inlet opening 102. The cap portion 118 of the device 100 instead provides cell cap portions 120 which includes the upper surfaces of the cells 101 providing the respective inlet openings 102. Accordingly, to assemble the device 100, the device body portion 117 is provided, and the device cap portion 118 is aligned such that each cell cap portion 120 corresponds to an appropriate cell body portion, and the device cap portion 118 is engaged with the device body portion 117 so as to seal off the cell body portions 119 (such that the respective internal channels are closed, other than at the respective inlet 102 and outlet 103 openings), thereby completing the device 100. The device cap portion 118 may be engaged with the device body portion 117 via a snap-fit mechanism, although various other engagement mechanisms could equally be used.

Of course, although not shown, the modular embodiments of FIGS. 4A and 4B can be combined, wherein a body portion 119 of a cell 101 may be placed within a grid structure 114 so as to form the body portion 117 of the device 100. Subsequently, the cap portion 118 of the device 100 may provide respective cap portions of cells 101 corresponding to the body portions 119 of cells, wherein engagement of the cap portion 118 of the device 100 with the body portion 117 of the device 100 axially retains the body portions 119 of cells 101 within the grid structure 114 and thus completes the assembly of the device 100.

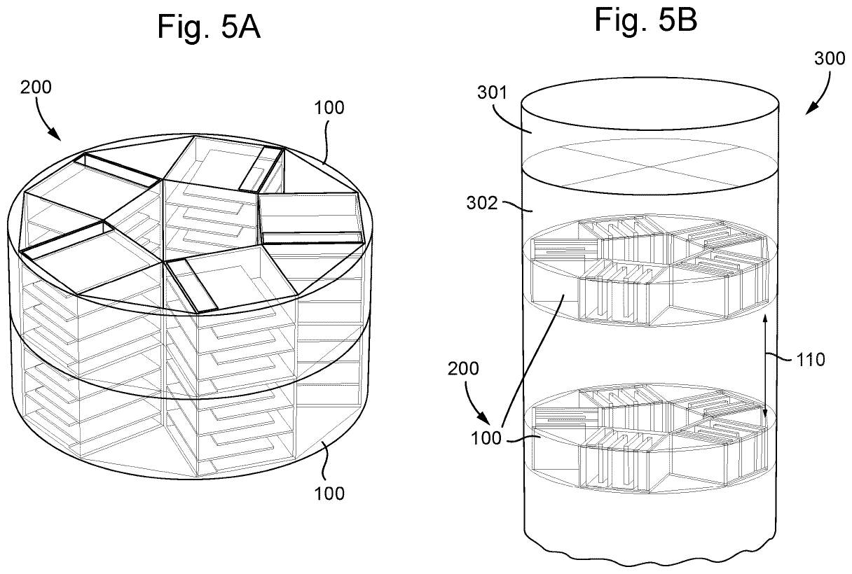

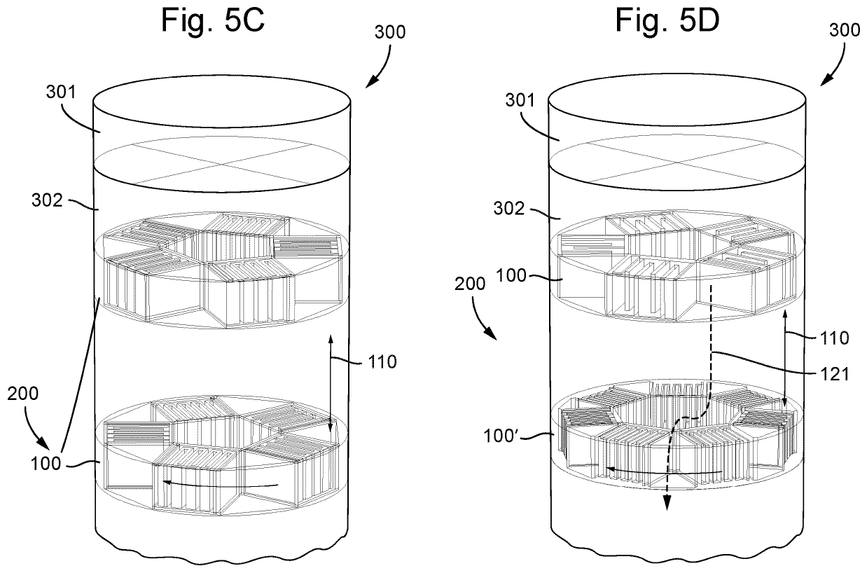

FIGS. 5A-5D show how multiple devices may be combined in series according to embodiments of the technology described herein.

FIG. 5A shows a device assembly 200 comprising a pair of devices 100 similar to that shown in FIG. 3E. As shown, the devices 100 may be rotationally aligned, and the cells 101 of each device may be structured such that the inlet opening 102 of each cell from one of the devices 100 is aligned with the respective outlet opening 103 of the correspondingly aligned cell 101 from the other of the devices 100.

However, as will be appreciated, this may not be the case for one or more of the cells 101. For instance, the inlet opening 102 of one or more cells 101 (but not all cells 101) from one of the devices 100 may not be aligned with the respective outlet opening 103 of the correspondingly aligned cell 101 from the other of the devices 100, such that the outlet opening 103 is effectively closed by the upper surface of the correspondingly aligned cell from the (i.e. downstream) device 100. In this way, some of the cells 101 will include only a single opening (be it the inlet 102 or outlet 103 openings). As will be understood, these particular cells may not impart a time delay to an acoustic wave propagating therethrough, nor will these cells permit flow to pass through. Rather, these cells may act as quarter-wavelength resonators, as well as being a blockage to the flow. As will be appreciated (and discussed further in FIG. 5C), rotating one of the devices with respect to the other dice (about the axial direction 110) may then open up the blocked cells once more.

FIGS. 5B and 5C show a system 300 including: a device assembly 200 comprising a pair of devices 100 similar to that shown in FIG. 3A; a source 301 for flow of air or another fluid (e.g., a fan or pump); and a flow conduit 302 for channelling the flow of air or another fluid (e.g. a pipe or other conduit such as a duct), according to embodiments. The two devices 100 can be shifted axially (i.e. along the axial direction 110) with respect to one another (as shown in FIG. 5B), either via an axial retention mechanism, or simply via shifting and being held via the walls of the flow conduit 302 itself. As will be appreciated, by shifting the devices 100 axially, greater noise reduction can be achieved. Moreover, as shown in FIG. 5C, the devices may alternatively or additionally be rotated relative to one another. As will be appreciated, above the noise reduction and flow properties though the conduit 302 may be controlled via the relative axially and rotational positioning of the two devices 100. For instance, as shown in particular in FIG. 5D, via relative rotation, a acoustic metamaterial cell 101 in one device 100 may at least partially overlap with a flow passage in the other device 100′ such that an additional tortuous flow path 121 is created between the two devices 100, 100′. A portion of an acoustic wave which propagates through the air or other fluid along this additional tortuous flow path 121 may also interfere with a portion of an acoustic wave e.g. propagating through the central flow passage (or even that having propagated through an adjacent cell 101 in device 100′), further changing the noise reduction properties of the device assembly 200.

Referring again to FIG. 5D, there is shown a system 300 including: a device assembly 200 comprising a first devices 100 similar to that shown in FIG. 3A and a second device similar to that shown in FIG. 1B; a source 301 for flow of air or another fluid (e.g., a fan or pump); and a flow conduit 302 for channelling the flow of air or another fluid (e.g. a pipe or other conduit such as a duct), according to embodiments. As will be appreciated, using different designs of device 100,100′ in the device assembly 200 affords even greater control over noise reduction capabilities and flow control capabilities.

Accordingly, an installer or technician can select the appropriate devices, install them within a system 300, and tune the relative positions of the device so as to achieve desired noise reduction (e.g., reducing noise from the source 301) whilst minimising the reduction in overall flow transmission through the flow conduit 302. For instance, faced with: (i) a minimum flow transmission threshold above which system 300 requires a certain flow transmission through a flow conduit 302; and (ii) a maximum noise threshold below which noise downstream must be reduced to, a technician can select the one or more appropriate devices 100,100′ and tune their relative positions until both parameters are met.

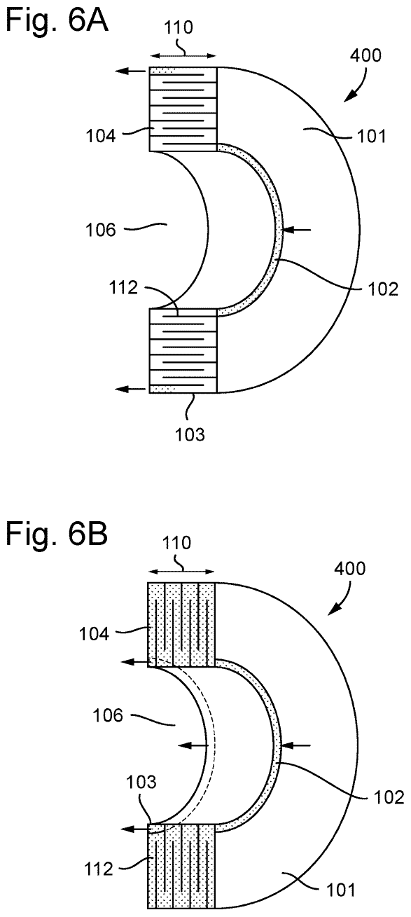

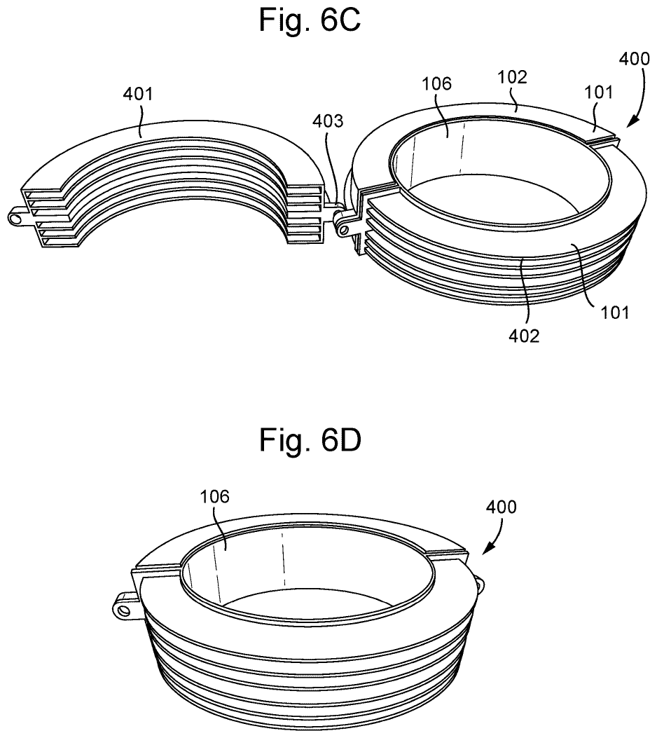

FIGS. 6A-6B show a cross-sectional view of a device 400 according to another embodiment of the technology described herein. In both, a single acoustic metamaterial cell 101 is extruded along a circular path so as to define the device 400, wherein the radially inward facing surface of the cell 101 defines the central flow passage 106.

In FIG. 6A, the internal channel 104 of the cell 101 is formed of staggered annular extrusions 112 (within the cell 101) which extend in the axial direction 110, such that the tortuous flow path so formed runs from the radially inner inlet opening 102, generally in the radial direction (averaged over the plurality of turns), to a radially outer outlet opening 103.

In FIG. 6B, the internal channel 104 of the cell 101 is formed of staggered annular extrusions 112 (within the cell 101) which extend in the radial direction (i.e. perpendicular to the axial direction 110), such that the tortuous flow path so formed runs from the radially inner inlet opening 102, generally in the axial direction 110 (averaged over the plurality of turns), to a radially inner outlet opening 103. In a similar way as described above in relation to the cell 101b in FIG. 1A, the outlet opening 103 in FIG. 6B can alternatively be a radially outer outlet opening 103.

As will be understood, the device 400 according to the embodiments of FIGS. 6A and 6B can be described as an acoustic diverging lens, which may reduce the noise generally along the axial direction by dispersion of the associated acoustic wave propagating through the air or other fluid therethrough.

FIGS. 6C and 6D show images a device 400 according to another embodiment of the technology described herein. Here, the device 400 is substantially similar to that shown in FIG. 6B, but is formed from a pair of acoustic metamaterial cells 101, extruded about semi-circles so as to define the central flow passage 106 between them. Each cell 101 may be formed from a respective cell body portion 402 and cell cap portion 401, which may be engaged together to form the internal channel 104 (not visible), and may be fixed together via fixation mechanism 403.

The device 400 according to the embodiments shown in FIGS. 6A-6D may be combined in a device assembly in a similar way as shown in FIGS. 5A-5D, i.e., with the devices 100 according to the embodiments shown in FIGS. 1-4.

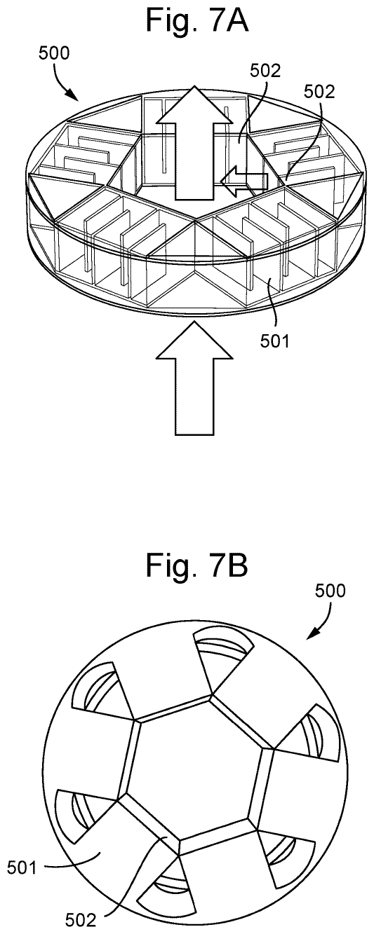

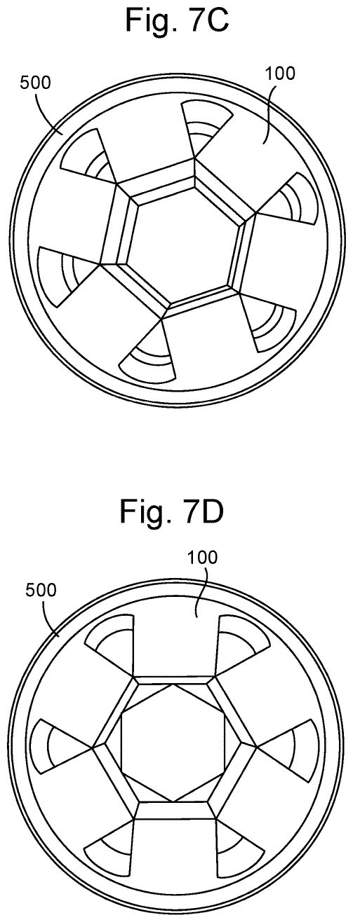

FIGS. 7A-7B show another example of a device 500, wherein the device 500 has cells 501 which each has only a single opening 502 lying in a plane parallel to the general flow direction. Accordingly, the cells may be considered as quarter-wavelength resonators, wherein the effective path length of the closed internal channel (i.e. having only a single opening 502) determines the wavelength at which the cell 501 exhibits the greatest response. As will be appreciated, such structures do not permit control over the flow dynamics, however may be optimized for attenuation of noise arising from acoustic reflections.

FIGS. 7C and 7D show combination of device 100 according to an embodiment of the technology described herein combined with the different noise attenuating device 500 (i.e., the one shown in FIG. 7B). FIG. 7C shows the two devices 100 and 500 in rotational alignment, whereas FIG. 7D shows the two devices rotationally misaligned with one another. As will be appreciated, the different noise reduction properties of the device 500 can be combined with the noise attenuation properties and flow control capabilities of the device 100, albeit with less control over the flow through the total device assembly as compared, e.g., to the embodiments of FIGS. 5A-5D.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A device for controlling noise, wherein the device comprises:
a flow passage that is open to allow air or another fluid to flow through the flow passage in a primary flow direction; and
one or more acoustic metamaterial cells, wherein each of the one or more acoustic metamaterial cells is provided with an inlet opening on a first side of the acoustic metamaterial cell, an outlet opening on a second, different side of the acoustic metamaterial cell, and an internal channel extending between the inlet and outlet openings and arranged to allow air or another fluid to flow between the inlet and outlet openings of the acoustic metamaterial cell through the internal channel of the acoustic metamaterial cell, and wherein each of the one or more acoustic metamaterial cells is structured such that the respective internal channel for the acoustic metamaterial cell provides a tortuous flow path through the acoustic metamaterial cell between the inlet and outlet openings, each acoustic metamaterial cell being configured to introduce a respective time delay to a portion of an acoustic wave incident at the inlet opening of the acoustic metamaterial cell based on the structure of the internal channel;
the one or more acoustic metamaterial cells being arranged relative to the flow passage such that when an acoustic wave propagating through air or another fluid is incident on the device, a first portion of the acoustic wave propagates through the flow passage and a second portion of the acoustic wave propagates through the one or more acoustic metamaterial cells, the second portion of the acoustic wave thereby being delayed relative to the first portion of the wave, and the first and second portions of the acoustic wave destructively interfere to provide noise reduction at one or more frequencies based on the respective time delays associated with the one or more acoustic metamaterial cells.

2. The device of claim 1, wherein the one or more acoustic metamaterial cells are arranged radially outwardly of the flow passage.

3. The device of claim 2, wherein the device comprises a plurality of acoustic metamaterial cells, wherein different ones of the plurality of acoustic metamaterial cells are arranged at different circumferential positions around the flow passage.

4. The device of claim 3, comprising one or more secondary flow passages provided between adjacent ones of the acoustic metamaterial cells.

5. The device of claim 3, wherein the plurality of acoustic metamaterial cells are arranged in a pentagonal or hexagonal arrangement.

6. The device of claim 2, comprising a prime number of acoustic metamaterial cells.

7. The device of claim 2, wherein the device comprises a plurality of identical acoustic metamaterial cells.

8. The device of claim 2, wherein the device comprises a number of different types of acoustic metamaterial cells, the different types of acoustic metamaterial cells being configured to introduce different respective time delays.

9. A kit of parts comprising:
a grid structure comprising one or more grid elements, each grid elements being configured to receive a respective acoustic metamaterial cell; and
a set of one or more acoustic metamaterial cells that can be inserted into the respective grid elements to provide a device for controlling noise,
wherein the device for controlling noise comprises:
a flow passage that is open to allow air or another fluid to flow through the flow passage in a primary flow direction; and
one or more acoustic metamaterial cells, wherein each of the one or more acoustic metamaterial cells is provided with an inlet opening on a first side of the acoustic metamaterial cell, an outlet opening on a second, different side of the acoustic metamaterial cell, and an internal channel extending between the inlet and outlet openings and arranged to allow air or another fluid to flow between the inlet and outlet openings of the acoustic metamaterial cell through the internal channel of the acoustic metamaterial cell, and wherein each of the one or more acoustic metamaterial cells is structured such that the respective internal channel for the acoustic metamaterial cell provides a tortuous flow path through the acoustic metamaterial cell between the inlet and outlet openings, each acoustic metamaterial cell being configured to introduce a respective time delay to a portion of an acoustic wave incident at the inlet opening of the acoustic metamaterial cell based on the structure of the internal channel;
the one or more acoustic metamaterial cells being arranged relative to the flow passage such that when an acoustic wave propagating through air or another fluid is incident on the device, a first portion of the acoustic wave propagates through the flow passage and a second portion of the acoustic wave propagates through the one or more acoustic metamaterial cells, the second portion of the acoustic wave thereby being delayed relative to the first portion of the wave, and the first and second portions of the acoustic wave destructively interfere to provide noise reduction at one or more frequencies based on the respective time delays associated with the one or more acoustic metamaterial cells.

10. The device of claim 1, wherein the internal channels of at least some of the one or more acoustic metamaterial cells comprise a set of one or more bars or extrusions that extend into the internal channel from respective inner walls of the acoustic metamaterial cell to define a labyrinthine or meandered flow path through the acoustic metamaterial cell.

11. The device of claim 10, wherein at least some of the one or more acoustic metamaterial cells comprise a set of interleaved bars that extend into the internal channel from different respective inner walls of the acoustic metamaterial cell.

12. The device of claim 10, wherein the spacing between bars is non-uniform.

13. The device of claim 1, wherein the tortuous flow path defined by the internal channel meanders in parallel to primary flow direction or wherein the tortuous flow path meanders perpendicularly to the primary flow direction.

14. The device of claim 1, wherein the one or more acoustic metamaterial cells define a first noise reducing assembly, and wherein the device further comprises a second noise reducing assembly axially spaced apart from the first noise reducing assembly in the primary flow direction.

15. The device of claim 14, wherein the second noise reducing assembly also comprises a corresponding set of one or more acoustic metamaterial cells.

16. The device of claim 14, wherein the first and second noise reducing assemblies can be rotated or otherwise moved relative to one another to selectively control the noise reduction function of the device.

17. The device of claim 1, wherein the one or more acoustic metamaterial cells are configured to act as a dispersive lens and/or wherein a dispersive lens is provided within the device.

18. The device of claim 1, wherein the arrangement of the one or more acoustic metamaterial cells can be manually re-configured to adjust the noise reduction function of the device.

19. An apparatus comprising:
a fan or pump;
a flow conduit for channelling air or another fluid from the fan or pump to an exhaust outlet; and
a device as claimed in claim 1 installed within or otherwise connected to the flow conduit for attenuating noise associated with the fan or pump.

20. A method of designing a device for controlling noise, wherein the device comprises:
a flow passage that is open to allow air or another fluid to flow through the flow passage in a primary flow direction; and
one or more acoustic metamaterial cells, wherein each of the one or more acoustic metamaterial cells is provided with an inlet opening on a first side of the acoustic metamaterial cell, an outlet opening on a second, different side of the acoustic metamaterial cell, and an internal channel extending between the inlet and outlet openings and arranged to allow air or another fluid to flow between the inlet and outlet openings of the acoustic metamaterial cell through the internal channel of the acoustic metamaterial cell, and wherein each of the one or more acoustic metamaterial cells is structured such that the respective internal channel for the acoustic metamaterial cell provides a tortuous flow path through the acoustic metamaterial cell between the inlet and outlet openings, each acoustic metamaterial cell being configured to introduce a respective time delay to a portion of an acoustic wave incident at the inlet opening of the acoustic metamaterial cell based on the structure of the internal channel;
the one or more acoustic metamaterial cells being arranged relative to the flow passage such that when an acoustic wave propagating through air or another fluid is incident on the device, a first portion of the acoustic wave propagates through the flow passage and a second portion of the acoustic wave propagates through the one or more acoustic metamaterial cells, the second portion of the acoustic wave thereby being delayed relative to the first portion of the wave, and the first and second portions of the acoustic wave destructively interfere to provide noise reduction at one or more frequencies based on the respective time delays associated with the one or more acoustic metamaterial cells, the method comprising:
determining one or more frequencies of noise to be reduced; and
selecting a desired arrangement of acoustic metamaterial cells to provide noise reduction at the determined one or more frequencies.
